(19) United States
(12) Patent Application Publication
(10) Pub. No.: US 2011/0319056 A1
(43) Pub. Date: Dec. 29, 2011

(54) REMOTE ACCESS TO A MOBILE DEVICE

(75) Inventors: Andrew Jong Kein Toy, New York, NY (US); Alexander Allan Trewby, London (GB); David Wei Zhu, Palo Alto, CA (US)

(73) Assignee: ENTERPROID HK LTD, Hong Kong (CN)

(21) Appl. No.: 12/825,902

(22) Filed: Jun. 29, 2010

(51) Int. Cl. H04W 68/00; G06F 21/00; H04L 9/32; G06F 3/01; G06F 15/16

(52) U.S. Cl. 455/412.2; 715/738; 726/7

(57) ABSTRACT

The disclosed subject matter relates to various architectures that can facilitate establishing a remote user interface (UI) by way of a secure connection session. The remote UI can reflect one or more interfaces extant on a mobile device (e.g., a smartphone with a Linux-based operating system (OS)), yet can be implemented on a remote device, typically of a higher form factor and/or equipped with superior computing, interface, and presentation resources. In particular, the remote UI can access all or a subset of the data or services extant on the mobile device.

### BACKGROUND

In the mobile device domain, advances in technology are rapidly leading to more powerful mobile devices that can store increasingly greater amounts of data and support increasingly more complex applications and operating systems. Simultaneously, with greater power available to mobile devices, new mobile applications are arising as well, which serves to drive even more data to mobile devices. Such data is often of a highly personal nature, and potentially important or even irreplaceable to the mobile device operator. Unfortunately, there are no convenient mechanisms available today to access such data or to access or leverage such useful mobile applications except through direct interaction with the mobile device, which has many limitations. For example, mobile devices can be easily misplaced and can often be unavailable for use (e.g., during battery charging). Moreover, mobile devices by design generally have limited form factors or other shortcomings that can degrade overall experiences vis-à-vis more powerful computing devices.

To alleviate some of the foregoing issues, various enterprises are entering the marketplace with products intended to replace or substitute some of the services commonly offered by mobile devices. For example, certain products can provide short message service (SMS) as a cloud service such that any device, mobile and non-mobile alike, can utilize SMS. Accordingly, richer interfaces or more features can potentially be provided for SMS (device permitting), yet rather than leveraging the services and data already extant on the mobile device, these services seek to replace functionality (e.g., a new SMS number, independent contacts store, etc.).

### SUMMARY

The following presents a simplified summary of the disclosed subject matter in order to provide a basic understanding of some aspects of the disclosed subject matter. This summary is not an extensive overview of the disclosed subject matter. It is intended to neither identify key or critical elements of the disclosed subject matter nor delineate the scope of the disclosed subject matter. Its sole purpose is to present some concepts of the disclosed subject matter in a simplified form as a prelude to the more detailed description that is presented later.

The subject matter disclosed herein, in one or more aspect thereof, comprises a first architecture that provide on a remote device a remote user interface (UI) associated with a mobile device. In accordance therewith and to other related ends, the architecture can operate to access, integrate with, and/or control existing services or data extant on the mobile device rather than attempting to replace or supplant mobile device functionality or services. In particular, the first architecture can include a notification component that can be configured to transmit a request to establish a secure connection session with a mobile device. The first architecture can also include a communication component that can be configured to utilize the secure connection session to access services associated with or data included in the mobile device. In addition, the first architecture can further include a UI component that can be configured to utilize local computer-based resources to construct a remote UI adapted to operate the mobile device

In one or more aspects, a second architecture can be provided that can securely interface a mobile device to a disparate device that operates a remote UI. In generally, the second architecture can include a data store that can maintain a public key of a public/private key pair associated with a mobile device, and a device ID associated with the mobile device. The second architecture can further include a connection component that can be configured to negotiate a secure connection session between the mobile device and a remote device configured to operate a remote UI for the mobile device.

Furthermore, in one or more aspect, a third architecture can be provided that can authenticate remote UI access to a mobile device by way of a secure connection session. The third architecture can include an acquisition component, which can be configured to receive a request to establish a secure connection session with a remote device configured to operate a remote UI. Additionally, the third architecture can include an authentication component that can be configured to authenticate and establish the secure connection session based upon information included in the request; as well as an interpretation component that can be configured to execute instructions received from the remote UI in accordance with a native mobile operating system (OS).

The following description and the annexed drawings set forth in detail certain illustrative aspects of the disclosed subject matter. These aspects are indicative, however, of but a few of the various ways in which the principles of the disclosed subject matter may be employed and the disclosed subject matter is intended to include all such aspects and their equivalents. Other advantages and distinguishing features of the disclosed subject matter will become apparent from the following detailed description of the disclosed subject matter when considered in conjunction with the drawings.

### BRIEF DESCRIPTION OF THE DRAWINGS

FIG. 1 is a block diagram of a system that can provide on a remote device a remote user interface (UI) associated with a mobile device.

FIG. 2 depicts a block diagram of a system that can provide a secure connection session with a central server that forwards information to and/or from a mobile device.

FIG. 3A illustrates a graphic illustration that provides a password-based depiction of an example output associated with a credential interface and/or credential application.

FIG. 3B depicts a graphic illustration that provides a pattern-based depiction of an example output associated with a credential interface and/or credential application.

FIG. 4 is a block diagram of a system that can securely interface a mobile device to a disparate device that operates a remote UI.

FIG. 5 depicts a block diagram of a system that can provide additional features or aspects with respect to securely interfacing a mobile device to a disparate device that operates a remote UI.

FIG. 6 illustrates a block diagram of a system that can authenticate remote UI access to a mobile device by way of a secure connection session.

FIG. 7 is an exemplary flow chart of procedures that define a method for providing a remote UI for a mobile device on a remote device.

FIG. 8 depicts an exemplary flow chart of procedures defining a method for providing additional features or aspects in connection with provision of a remote UI for a mobile device on a remote device.

FIG. 9 provides an exemplary flow chart of procedures defining a method for providing additional features or aspects in connection with a mobile device coupled with a remote UI by way of a secure communication session.

FIG. 10 illustrates an example wireless communication environment with associated components that can enable operation of an enterprise network in accordance with aspects described herein.

FIG. 11 illustrates a block diagram of a computer operable to execute or implement all or portions of the disclosed architecture.

FIG. 12 illustrates a schematic block diagram of an exemplary computing environment.

### DETAILED DESCRIPTION

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

As used in this application, the terms “system,” “component,” “interface,” and the like are intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. These components also can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or API components.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed subject matter.

Further, terms like “user equipment,” “mobile device,” “mobile,” subscriber station,” “access terminal,” “terminal,” “handset,” and similar terminology, generally refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “cell,” “cell site,” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

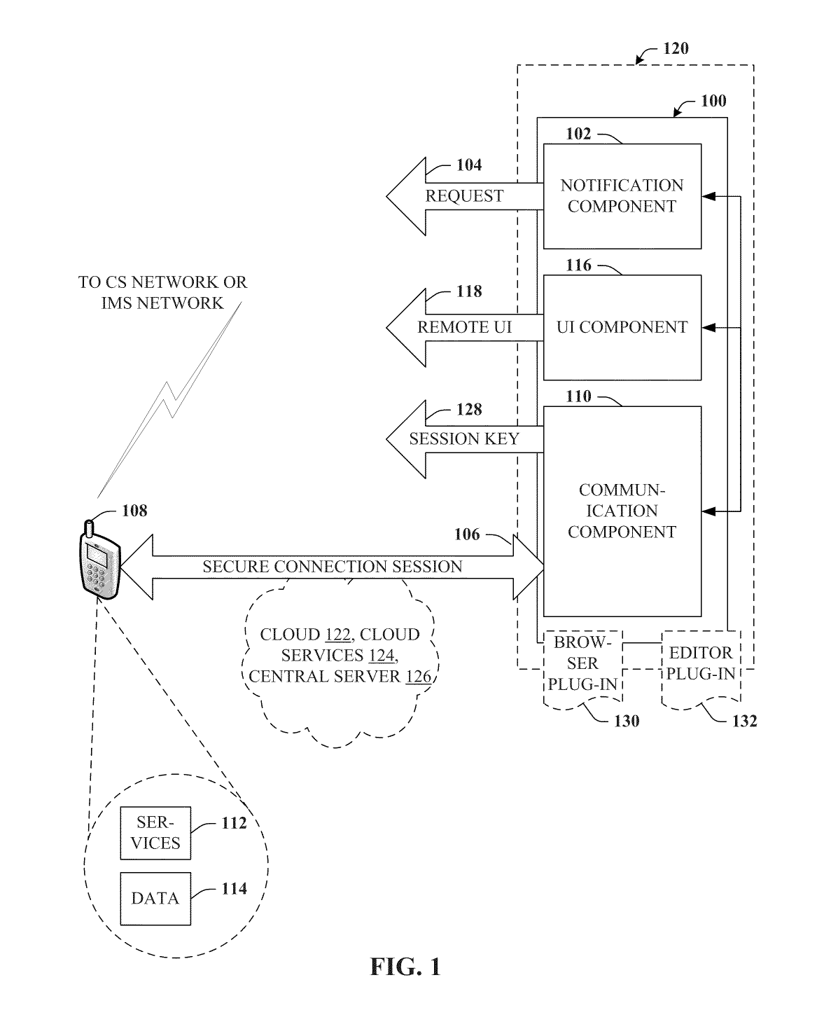

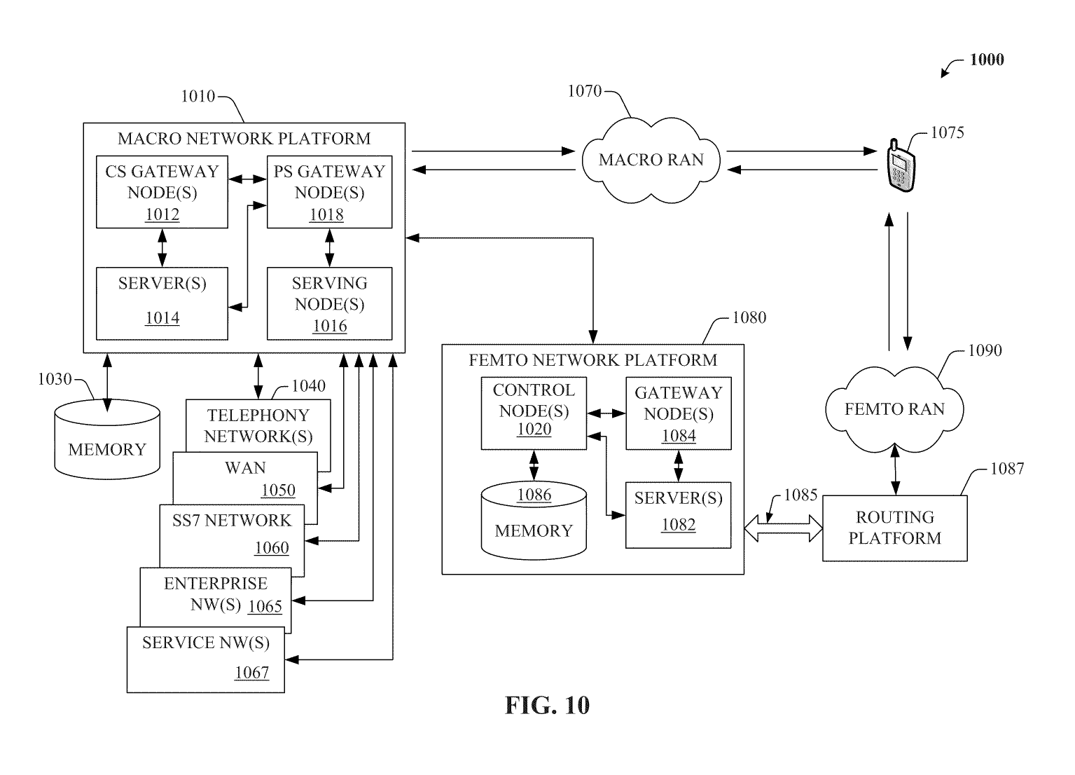

Referring now to the drawings, with reference initially to FIG. 1, system 100 that can provide on a remote device a remote user interface (UI) associated with a mobile device is depicted. In one or more aspect, system 100 can be a lightweight application (potentially embodied in a computer-readable medium or as software in execution by a processor) included in remote device 120, which can be substantially any suitable computer-related device. For example, remote device 120 will typically be a device with a larger form factor and/or increased computational power, memory, or other resources relative to mobile device 108, such as, e.g., a personal computer (PC), laptop, netbook, smartbook, or tablet. However, it should be appreciated that remote device 120 can in certain aspects be a conventional mobile device as well, for instance a mobile device with hardware dedicated to and service provisions allocating WIFI communication features in addition to standard forms of communication via circuit switching (CS) or Internet protocol multimedia subsystem (IMS) networks. Such standard forms of communication can be, e.g., via cellular base stations or via HNB/femtocells, both of which are further detailed in connection with FIG. 10, infra.

On the other hand, mobile device 108 will typically be, e.g., a smartphone, personal digital assistant (PDA), smartbook or the like, that normally offers more advanced computing power relative to legacy cellular phones and a full-featured operating system (OS). However, in some cases, mobile device can be a conventional cellular phone, e.g., one that supports generic platforms such as Java ME or BREW. In one or more specific embodiment, mobile device 108 is substantially any device that operates in accordance with an Android OS platform or another Linux-based, Unix-based, or open source-based mobile OS platform.

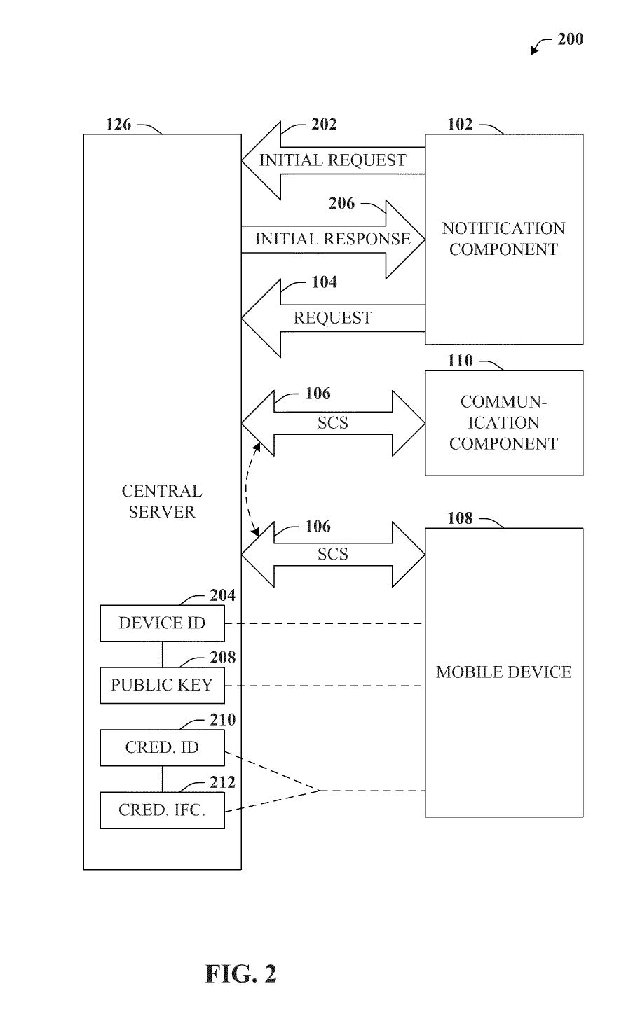

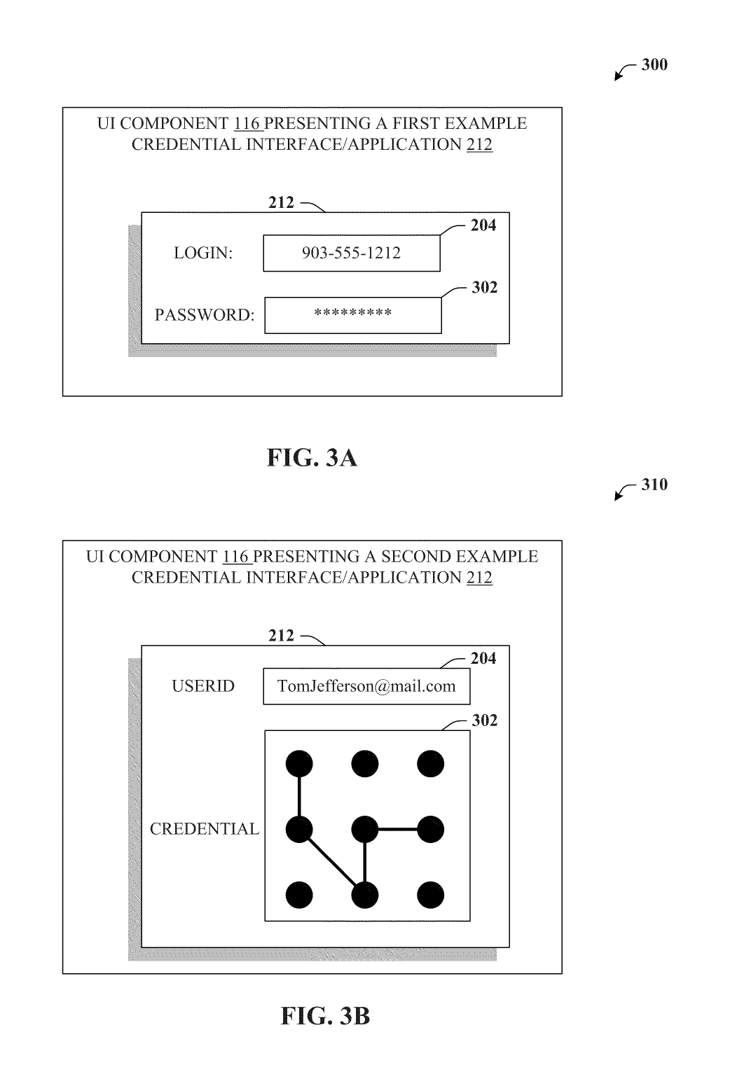

Generally, system 100 can include notification component 102 that can be configured to transmit request 104. Request 104 can relate to, e.g., an instruction to establish secure connection session 106 with mobile device 108. In one or more aspect, request 104 can include a credential that is identical to a native credential utilized by mobile device 108 to authenticate access to all or a portion of services 112 or data 114. Additional features or aspects associated with the credential are detailed with reference to FIGS. 2, 3A, and 3B.

Typically, secure connection session 106 will relate to a bi-directional channel or data path dedicated to communication between mobile device 108 and remote device 120. Moreover, secure connection session 106 will normally be configured to persist (or rebuild if closed due to network faults or the like) until affirmatively instructed to terminate or upon expiration of a long-term (e.g., multi-hour or multi-day) timeout counter. Accordingly, secure connection session 106 can remain live and therefore not time out due to infrequent use or upon satisfying a query or instruction. Furthermore, any suitable networking protocol can be employed for creating and/or maintaining secure connection session 106, but packets, datagrams, or other data payloads or traffic between remote device 120 and mobile device 108 and will normally be encrypted or otherwise secured or authenticated, which is further discussed infra.

In addition, system 100 can also include communication component 110 that can be configured to utilize secure connection session 106 to access services 112 (e.g., short message service (SMS)) associated with, or data 114 (e.g., contacts) included in, mobile device 108. In other words, communication component 110 can aid in setting up, managing, and/or maintaining secure connection session 106 so that components of system 100 or remote device 120 can be provided secure access to services 112 or data 114.

System 100 can further include UI component 116 that can be configured to utilize local computer-based resources (e.g., resources available to or included in remote device 120) to construct remote UI 118, wherein remote UI 118 can be adapted to operate and/or interact with mobile device 108, e.g., via secure connection session 106. Additional features and/or aspects associated with remote UI 118 are further detailed infra. However, as a brief introduction, remote UI 118 can present a notification regarding incoming telephony events (e.g., calls, SMS, . . . ). Hence, the notification can alert a subscriber of, e.g., “Text message received from John Smith,” which can appear in the remote UI 118 of remote device 120 in addition to or alternatively to the mobile device 108. If remote UI 118 is running minimized (e.g., to a system tray or toolbar), the notification can appear as a popup or the like. Moreover, remote UI 118 can also include the contents of the text message and allow a reply to be sent, potentially input via a more robust UI (e.g., full-featured, tactile, keyboard versus mobile device 108 keyboard). Regardless, the reply can be forwarded to mobile device 108 by way of secure connection session 106, and then transmitted to John Smith's device in a seamless fashion as though the SMS was input and sent based upon interaction with mobile device 108 alone.

In accordance with the above, it can be readily appreciated that remote UI 118 can provide a number of advantages. For example, mobile devices (e.g., mobile device 108) are increasingly becoming a central feature in a user's life in terms of, e.g., personal data, relationships, activities, or transactions. Hence, while mobile devices are continually evolving to store more information, associated application designed for these mobile devices are also evolving to push more information to the mobile device as well (e.g., to be leveraged in unique ways by these applications). Accordingly, given the wealth of data (e.g., data 114) and services (e.g., services 112) included in certain mobile devices, the ability to access such data remotely, can effectively transform mobile devices into robust personal servers, potentially including data or services not available elsewhere, and potentially conveniently accessible on demand.

On the other hand, given that remote device 120 will typically be more robust in terms of form factor (e.g., more screen real estate, better resolution, superior UI elements such as keyboard, mouse, etc.), processing power and so forth, the overall experience provided when accessing services 112 or data 114 by way of remote UI 118 can be significantly enhanced. Moreover, remote device 120 can potentially provide access to additional data sets, services, or feature sets not included in or not available for mobile device 108, which can also be effectively leveraged by the disclosed subject matter. Furthermore, remote UI 118, in addition to potentially enhancing certain experiences or providing additional features, can also afford enhanced convenience over physically operating the associated mobile device 108.

For instance, consider the following three scenarios intended to provide concrete illustrations to underscore additional convenience afforded by remote UI 118 in common situations, but which are not necessarily intended to limit the appended claims. Consider two users, Ashley and Ross, both of whom maintain suitable mobile devices 108 (and associated service provisions from a wireless carrier). In a first scenario, Ashley is relaxing on her sofa with her iPad (e.g., remote device 120) in her lap and remote UI 118 initiated and running in the background. Meanwhile, Ashley's mobile device 108 is resting on a charger in her bedroom at the time of some event or transaction associated with her mobile device 108. Ashley can conveniently observe, interact with, respond to, or even initiate the event or transaction from the comfort of her sofa and without interrupting the charging process of her mobile device.

As a second example, consider the case in which Ross arrives at home from work only to realize he left his mobile device 108 at the office. Even though Ross is expecting a communication from an important business client later that evening, he does not particularly want to return to the office for his mobile device 108, and could potentially miss the communication en route regardless. Hence, Ross boots up his PC and activates remote UI 118. As a third example, consider the case in which either Ashley or Ross disabled the ringer for mobile device 108 prior to an important meeting, and forget to reactivate the ringer afterwards. Thus, an incoming event might well go unnoticed, even if mobile device 108 is handy, say in one's jacket pocket, yet the associated notification (either visual or audible) from remote UI 118 can serve as an independent mechanism to avoid missing the incoming event.

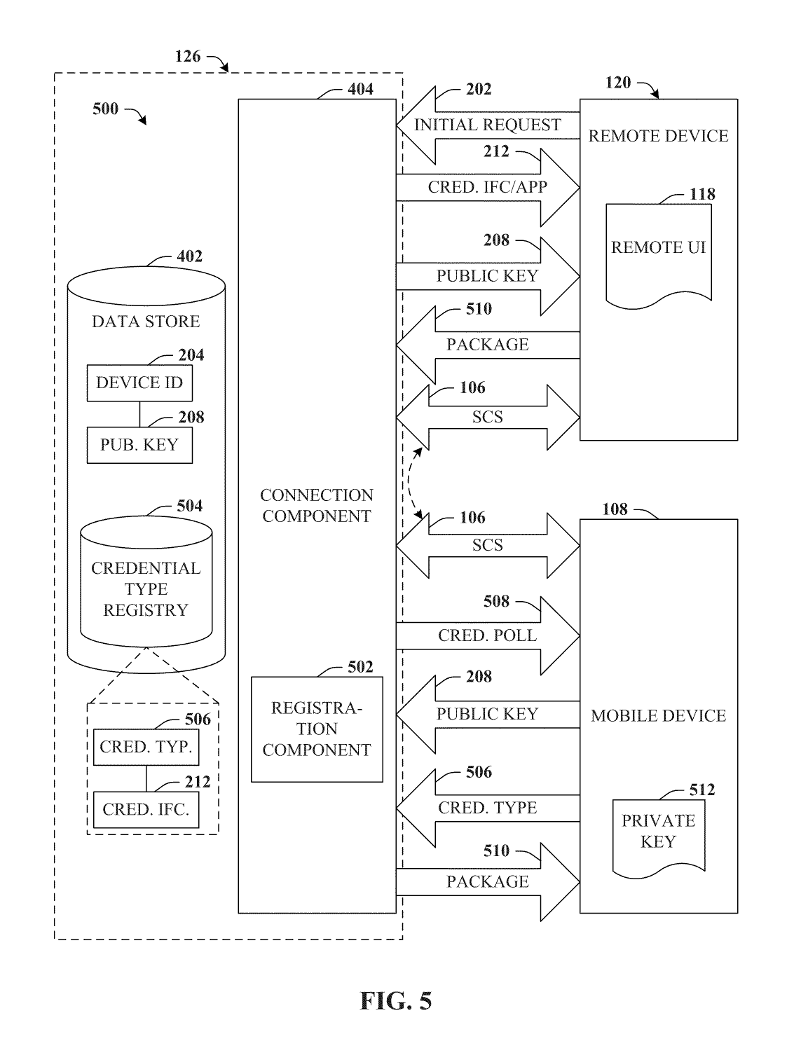

Continuing the discussion of FIG. 1, it should be appreciated that although secure connection session 106 is depicted as a direct connection between mobile device 108 and remote device 120 (and/or communication component 110), such need not be the case for all implementations. For example, in one or more aspect, secure connection session 106 can be directed through cloud 122 or supported by cloud service 124, either or both of which can be facilitated by central server 126, which is further detailed herein, particularly with reference to FIGS. 2 and 5 below. Regardless of the actual implementation, additional discussion with respect to establishing secure connection session 106 can now be provided, which for the remainder of this document is described in terms of utilization of central server 126 that, inter alia, substantially operates as a certificate authority or registration authority for public key infrastructure (PKI) encryption scheme. However, it should be appreciated that other means or mechanisms can exist and be employed in connection with the disclosed subject matter.

While still referring to FIG. 1, but turning now as well and in turn to FIGS. 2, 3A, and 3B, various additional aspects are provided regarding an example implementation of secure connection session 106. Initially, with particular reference to FIG. 2, system 200 that can provide a secure connection session with a central server that forwards information to and/or from mobile device 108 is illustrated. System 200 can include notification component 102 that can transmit request 104 to establish secure connection session 106 with mobile device 108 as substantially detailed supra in connection with system 100 of FIG. 1. Additionally, in one or more aspect, notification component 102 can transmit initial request 202 to central server 126, which can be configured to operate cloud service 124 to support remote UI 118.

Generally, initial request 202 can include device ID 202 that can in some manner describe or be associated with mobile device 108. For example, device ID 204 can be a phone number associated with mobile device 108, or a user name or email address of a user that is linked to that phone number or other description of mobile device 108 maintained by central server 126. Regardless of the nature or form of device ID 204, such information should be sufficient for central server 126 to identify the target mobile device 108, based upon other information stored in central server 126, potentially previously acquired in connection with a registration process that is further discussed with reference to FIG. 5.

Furthermore, notification component 102 can receive initial response 206 from central server 126, e.g., in answer to initial request 202. Initial response 206 can include a public key portion (e.g., public key 208) of a public/private key pair associated with mobile device 108. In addition, initial response 206 can also include credential ID 210 that can define a credential type required to authenticate access to mobile device 108. In either case, public key 208 and/or credential ID 210, will generally be acquired from mobile device 108 in advance as a result of a registration process, but can in some circumstances be acquired contemporaneously with receipt of initial request 202 by polling mobile device 108 for the required information. As noted previously, request 104 can include a credential that is identical to a native credential utilized by mobile device 108 to authenticate access to all or a portion of service 112 or data 114. This credential can be a password, or it could be something else such as a pattern, puzzle, or key etc. However, regardless of the nature of the credential, remote device 120 will likely need to know how to properly set up a credential input mechanism. For example, if the native credential relates to solving a puzzle or inputting a particular pattern, then a standard password box for obtaining the credential might prove to be inadequate. Hence, in one or more aspect, potentially upon receipt of initial response 206 by notification component 102, UI component 116 can present credential interface 212 based upon the credential type defined by credential ID 210, which is further detailed with reference to FIGS. 3A and 3B.

Referring briefly now to FIGS. 3A and 3B, respectively, graphic illustration 300 provides a password-based depiction of an example output associated with a credential interface and/or credential application, whereas graphic illustration 310 provides a pattern-based depiction of an example output associated with a credential interface and/or credential application. In particular, credential interface 212 of graphic illustration 300 illustrates the case in which device ID 204 is formulated as a telephone number and credential 302 is a secret password or the like. In contrast, graphic illustration 310 presents an example of device ID 204 in the form of a user email address (which can be matched to the target device), whereas credential 302 in this case relates to a spatial pattern.

Appreciably, UI component 116 can present initially only the login/userID input box, and populate the password/credential area after receiving device ID 204 as input. Once device ID 204 is obtained, such can be transmitted to central server 126, which can look up in associated data stores or interface with mobile device 108 in order to ascertain the type of credential mobile device 108 expects, which can be defined by credential ID 210. Once the credential type and/or credential ID 210 is known, an associated credential interface or application 212 can be provided to UI component 116, which can then be presented during a login process as illustrated in FIGS. 3A and 3B.

Turning back to FIGS. 1 and 2, once notification component 102 receives initial response 206 (potentially including pubic key 208 and credential ID 210 and/or credential interface 212) and UI component 212 has received credential 302 input, then request 104 can be constructed and delivered to central server 126 by way of notification component 102. In particular, communication component 110 can employ public key 208 to encrypt a package to be included in request 104. This package can include credential 302 that was input to credential interface 212 (and which ostensibly matches a native credential employed by mobile device 108). Furthermore, the package can include session key 128 that can be configured to encrypt communications propagated by way of secure connection session 106. Session key 128 will typically be constructed by communication component 110 (or another suitable component of the remote device 120), but in some cases, can be created by central server 126 or mobile device 108 and delivered to remote device 120, e.g., as part of initial response 206.

Regardless, request 104 (including the encrypted package payload) can be forwarded to mobile device 108 and secure connection session 106 established as further discussed in connection with FIG. 5. Once accomplished, UI component 116 can then construct remote UI 118 that can then be employed to remotely operate and/or access mobile device 108 as further detailed herein. In one or more aspect, remote UI 118 can include a desktop UI that can emulate or copy all or a portion of at least one native display provided by an OS of remote device 108. Thus, backgrounds, settings, objects, icons, folders, menus to name but a few that are provided by mobile device 108 can be presented on remote UI 118, with associated data 114 and services 112 available as well.

As another example, remote UI 118 can include a SMS UI that accesses a native SMS provided by mobile device 108. Accordingly, SMS provided by mobile device 108 can be utilized at remote UI 118 to, e.g., send messages to or receive messages from various third party entities. Likewise, remote UI 118 can also include a phone UI that can access a native phone service provided by mobile device 108 and/or a contacts UI that can access a native contacts data store maintained by mobile device 108. Thus, access to contacts and phone services as well as other telephony events can be bootstrapped to remote device. It should be appreciated that a user can potentially be afforded full-featured phone support on remote device 120 via remote UI 118, provided remote device 120 maintains necessary components (e.g., a microphone, speakers, etc.).

For example, well-known voice-over-Internet-protocol (VOIP) techniques, as well as other suitable techniques can be employed to relay voice or other (e.g., video) suitable data between remote UI 118 and mobile device 108. Alternatively, remote UI 118 can command mobile device 108 to answer (or initiate outgoing) calls, perhaps in speaker phone mode, Bluetooth mode, or in accordance with any other suitable setting. As yet another example, even assuming remote device 120 is not equipped with a microphone, but does have a speaker, various telephony events can still be supported, such as accessing voicemail and outputting the contents at remote device 120, with mobile phone 108 employed to transmit key codes for passwords or menu options as instructed by remote UI 118.

With regard to contacts data, say, in connection with the contacts UI as well as potentially any other data 114 available from mobile device 108, it should be understood that remote UI 118 (or portions thereof) need not necessarily retrieve entire data sets at the outset. Rather, in one or more aspect, UI component 116 can download (possible via central server 126) a designated portion or fraction of data 114 or services 112 available from mobile device 108, e.g., based upon a context associated with usage or a priority applied to individual data elements. Moreover, UI component 116 can employ the portion of data or services to populate remote UI 118 (or a sub-UI). For instance, consider the case where mobile device 108 maintains hundreds of contacts. Instead of downloading the entire set of contacts to populate the contacts UI, a particular subset of contacts can be downloaded instead, with remaining data elements downloaded on an as-needed basis, e.g., framed as a query from remote UI 118 to mobile device 108. The particular subset can be predetermined or determined on the fly based upon priority or context, and, hence, selected automatically based upon, e.g., a list of contacts associated with most recent calls (or texts or other telephony events), most commonly called, missed calls, unread texts, or the like.

It should be appreciated that the above examples of various types of specific UIs that can be provided by UI component 116 are intended to be exemplary, but should not necessarily be deemed to limit the disclosed subject matter. Rather, various other types of UIs are envisioned, and can be utilized in connection with the disclosed subject matter. For example, remote UI 118 can include and/or relate to UIs associated with, e.g., a calendar application, an email application, a phone log application, browser application as well as browser history or bookmarks, a camera display or application, an audio application, a microphone application, a GPS/Location-based application, an accelerometer application, light emitted diode (LED) displays, controls, or applications, a compass application, and so forth.

Continuing the discussion of FIG. 1, in one or more aspect, UI component 116 can present (e.g., by way of remote UI 118) an indication of one or more telephony events received by or transmitted by mobile device 108. The form or nature of the indication presented by UI component 116 can be based upon a type of the one or more telephony event (e.g., call versus text, incoming versus outgoing . . . ). Regardless, the indication can include a description of the type of telephony event, an identification of a sender or recipient of the one or more telephony event, and/or contents associated with the one or more telephony event. As noted supra, the indication can automatically populate remote UI 118 or be delivered as a pop-up message or ticker or the like.

Moreover, in one or more aspect, and as introduced previously, UI component 116 can provide a set of controls for managing the one or more telephony event, wherein the set of controls can be presented and/or available in their entirety, or can be contextually filtered based upon the type of telephony event. For example, the set of controls can include a control to utilize local resources to answer or initiate a call (e.g., by way of VOIP techniques). Likewise, the set of controls can include a control to utilize native resources to answer or initiate a call (e.g., unhook mobile device 108 line and activate speaker phone or Bluetooth options). As other suitable examples, the set can include controls for ignoring an incoming call, forwarding an incoming call to another number or to voicemail, presenting or masking contents of an incoming SMS, initiating an outgoing SMS, employing speech-to-text for presenting contents of a voice message, employing text-to-speech for transmitting contents of a message in audio form, or to query and/or download additional data 114 or services 112 associated with mobile device 108.

In addition, in one or more aspect, system 100 can further include browser plug-in 130, which can leverage browser applications resident on remote device 120. Browser plug-in 130 can be configured to identify a phone number included in data to be rendered in the browser (e.g., potentially prior to actual rendering). Browser plug-in 130 can then automatically convert an identified phone number to an interactive link displayed in the browser, e.g., with associated visual indicia similar to treatment provided hyperlinks by conventional browsers. Upon activation of the interactive link (e.g., a mouse-click), the interactive link can facilitate transmission of the identified phone number to mobile device 108 by way of remote UI 118. Accordingly, when a user is, e.g., browsing reviews relating to restaurants certain contact information (e.g., phone numbers, street address) can be automatically embedded with the interactive link, such that clicking the link can conveniently allow the user to store the number or street address to native contacts associated with mobile device 108 or to initiate a call to that number.

Furthermore, in one or more aspect, system 100 can also include editor plug-in 132, which can leverage word processing and/or editor applications operating on remote device 120. Editor plug-in 132 can be configured to provide an option to automatically transmit highlighted (or otherwise selected) text input to the editor application to a native SMS of mobile device 108 by way of remote UI 118. For example, editor plug-in 132 can embed a contextual menu option (e.g., accessed via right-clicking or the like) to instruct highlighted text to be captured and submitted as a SMS.

Moreover, while in some implementations system 100 can allow all or portions of data 114 or services 112 retrieved from mobile device 108 to persist on remote device 120 (e.g., in long-term storage on a user's device), in other implementations such need not be the case. For example, in one or more aspect, UI component 116 can erase or release data stored on local resources (e.g., to volatile or non-volatile storage media) upon termination of secure connection session 106. For the sake of security, the latter option can often be desirable, especially in cases where remote device 120 is a public-access terminal or the like.

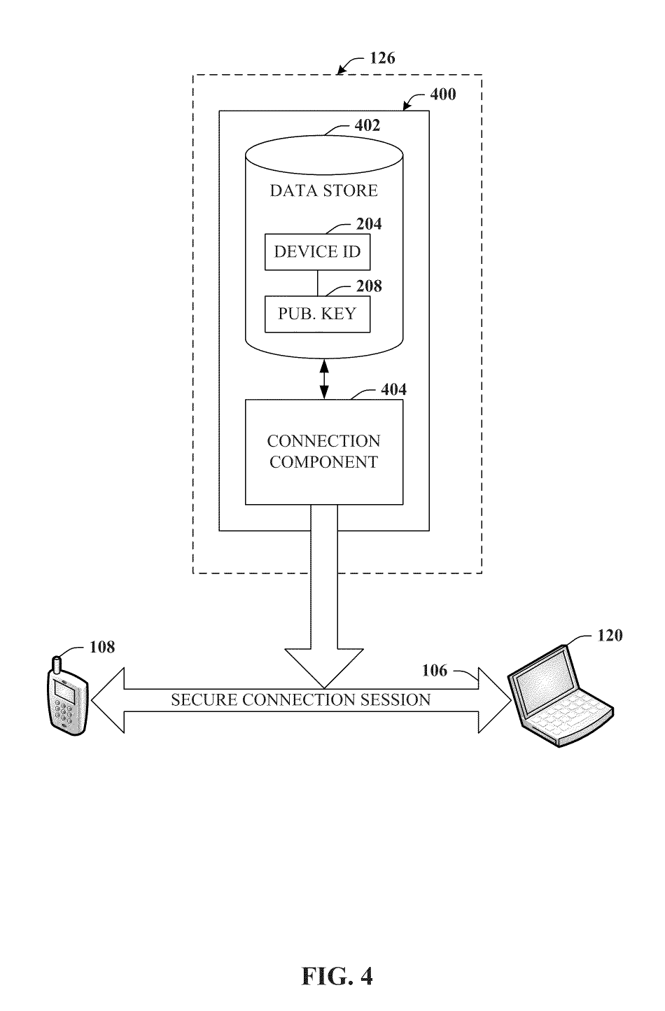

Referring now to FIG. 4, system 400 that can securely interface a mobile device to a disparate device that operates a remote UI is illustrated. In general, system 400 can reside in central server 126, which can operate as or host a cloud 122 or cloud services 124, as detailed in connection with FIG. 1. System 400 can include data store 402 that can store device ID 204 associated with mobile device 108 as well as public key 208 that can be bound to device ID 204 and can represent the public key portion of a public/private key pair associated with mobile device 108.

In addition, system 400 can also include connection component 404 that can be configured to negotiate secure connection session 106 between mobile device 108 and remote device 120 configured to operate a remote UI (e.g., remote UI 118) for mobile device 108. In broad terms, system 400 can distinctly operate as both a data path intermediary for secure connection session 106 and to operate as a certificate authority or registration authority for a PKI scheme that enables secure connection session 106, all of which is further described with reference to FIG. 5.

Now turning to FIG. 5, system 500 that can provide additional features or aspects with respect to securely interfacing a mobile device to a disparate device that operates a remote UI is depicted. Typically, system 500 can include data store 402 and connection component 404 as substantially described supra in connection with FIG. 4. In addition, in one or more aspect, system 500 can also include registration component 502 that can be configured to bind public key 208 to device ID 204, e.g., during a registration process that associates and stores public key 208 and device ID 204 to data store 402. Appreciably, registration component 502 can be operatively or communicatively coupled to connection component 404 or, as drawn in FIG. 5, embedded or included in connection component 502.

Moreover, in addition to housing device ID 204 and public key 208, data store 402 can include various other information. For example, in one or more aspect data store 402 can further store credential type registry 504 that can maintain a set of credential types 506 (e.g., each type can be associated with a particular credential ID as detailed with respect to credential ID 210) as well as an associated set of credential type interfaces or applications 212.

In accordance with the above, connection component 404 can negotiate secure connection session 106 based upon initial request 202 from remote device 120, wherein initial request 202 can include device ID 204 as detailed in connection with FIG. 2. For example, upon receiving initial request 202, connection component 404 can extract or match device ID 204 to mobile device 108 and then poll (e.g., via credential poll 508) mobile device 108 to determine the appropriate credential type 506. Alternatively, connection component 404 can access data store 402 to lookup this information, however, such stored data can be stale (e.g., the credential type can be changed on mobile device 108 in the interim), thus credential poll 508 is generally the preferred means of obtaining credential type 506.

Regardless, connection component 404 can then retrieve an associated credential interface or application 212 from credential registry 504 described by credential type 506. Connection component 404 can further retrieve public key 208 associated with mobile device 108 from data store 402, and transmit credential type interface/application 212 and public key 208 to remote device 120 (e.g., similar to initial response 206 detailed in connection with FIG. 2). In response, connection component 404 can receive from remote device 120 package 510, which can be encrypted at remote device 120 with public key 208. Accordingly, package 510 will generally only be decryptable by the associated private key maintained on mobile device 108 (e.g., private key 512). Package 510 can be a constituent of request 104 detailed with respect to FIGS. 1 and 2 and can include one or both credential 302 derived from credential type interface/application 212 or session key 128 configured to encrypt messages traversing secure connection session 106, all of which can be encrypted by public key 208 to be decrypted by private key 512. Upon receipt of package 510, connection component 404 can forward package 510 to mobile device 108 as a request to establish secure connection session 106.

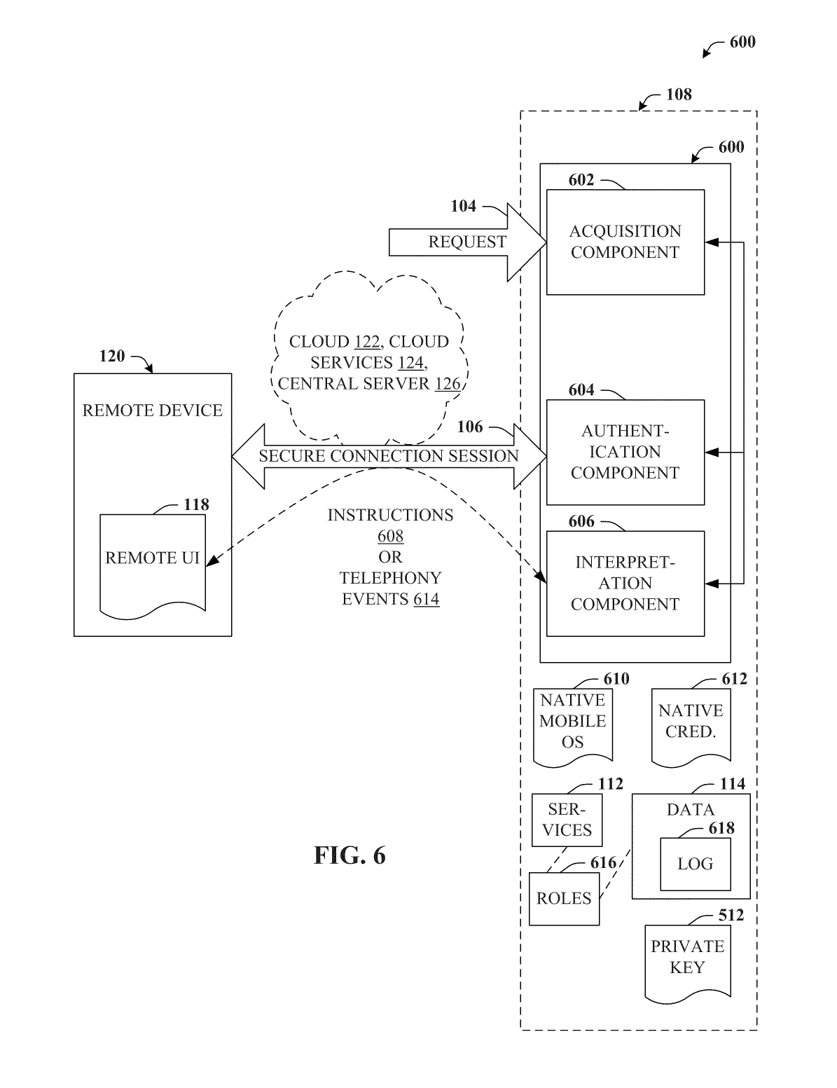

With reference now to FIG. 6, system 600 that can authenticate remote UI access to a mobile device by way of a secure connection session is provided. Generally, system 600 can be included in a mobile device such as mobile device 108, potentially embodied in a computer readable medium or as software in execution. Moreover, system 600 can be implemented entirely or in part as an application or as part of a mobile OS such as Android, WebOS, Maemo and so forth.

Typically, system 600 can include acquisition component 602 that can be configured to receive request 104 to establish secure connection session 106 with remote device 120 which can be configured to operate remote UI 118. As detailed, request 104 can be received directly from remote device 120 or by way of central server 126 or cloud 122 or cloud service 124 associated with central server 126. Moreover, in one or more aspect, request 104 can include at least one of session key 128 that can be configured to encrypt communications propagated by way of secure connection session 106, or credential 302 that can be identical to native credential 612 utilized by native mobile OS 610 to authenticate at least one of a login, a release of a screen lock, or access to all or a portion of native services 112 or data 114.

In one or more aspect, native mobile OS 610 can be configured to support multiple native credentials 612, wherein each or a particular native credential 612 input to a native credential interface can define an associated contextual role that potentially utilizes unique data sets, policies, services, or settings, which differ from other contextual roles associated with other of the multiple native credentials 612 supported by native mobile OS 610. Hence, for example, a single user can log into mobile device 108 under a business context/role by inputting a first native credential 612 (e.g., upon login or to release a screen lock), whereupon only business contacts will (or other data 114 or services 112) will be available. In contrast, the same user can log into mobile device 108 under a personal context/role by inputting a second native credential 612, thereby gaining access to distinct sets of data 114, services 112, and so on with a distinct experience and different levels of security or policies, etc. Appreciably, such multiple role features can be extended to remote UI 118

Furthermore, system 600 can further include authentication component 604 that can be configured to authenticate and establish secure connection session 106 based upon information included in request 104. For example, request 104 can include an encrypted package (e.g., package 510) comprising, e.g., session key 128 and credential 302. This package can be encrypted at remote device 120 with public key 208 configured such that only private key 512, residing securely within mobile device 108, can be used for decrypting the package. Regardless, once decrypted, assuming credential 302 matches native credential 612, secure connection session 106 can be established. In addition, system 600 can also include interpretation component 606 that can be configured to execute instructions 608 received from remote UI 118 in accordance with native mobile OS 610. Hence, instructions 608 received from remote UI 118 can have a similar or identical effect to related instructions input directly to mobile device 108 via an associated mobile UI.

In one or more aspect, interpretation component 606 can be configured to forward suitable telephony events 614 to remote UI 118 while secure connection session 106 persists. For example, just as conventional mobile operating systems inform native applications of certain events (e.g., telephony events 614 such as incoming calls or texts), similar techniques or technologies can be employed to do the same for remote UI 118. Accordingly, interpretation component 606 can log (e.g., store to log 618) telephony events 614 according to protocol independently of whether or not telephony events are forwarded to or originate from remote UI 118.

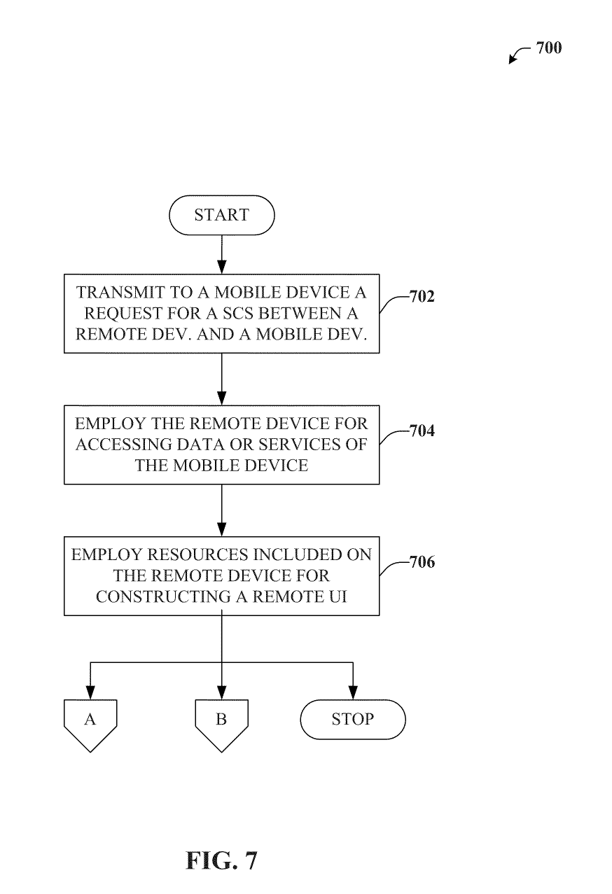

FIGS. 7-9 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 7, exemplary method 700 for providing a remote UI for a mobile device on a remote device is depicted. Generally, at reference numeral 702, a request for a secure communication session between a remote device and a mobile device can be transmitted to the mobile device. Accordingly, the secure communication session can be established based at least in part upon information included in the request.

At reference numeral 704, the remote device can be employed for accessing data included in or services associated with the mobile device by way of the secure communication session. For example, the remote device can access a set of contacts stored in mobile device (or other suitable data). As another example, remote device can leverage SMS provided by mobile device to send or receive text messages; or access and utilize other suitable services, remotely.

Next to be described, at reference numeral 706, computer-related resources included on the remote device can be employed for constructing a remote UI configured for operating the mobile device. Thus, displays, keyboards, mice, local processor(s), local memory, or other local resources can be employed to run remote UI, which can yield a distinct and potentially superior and more convenient experience in connection with data or services existing on the mobile device.

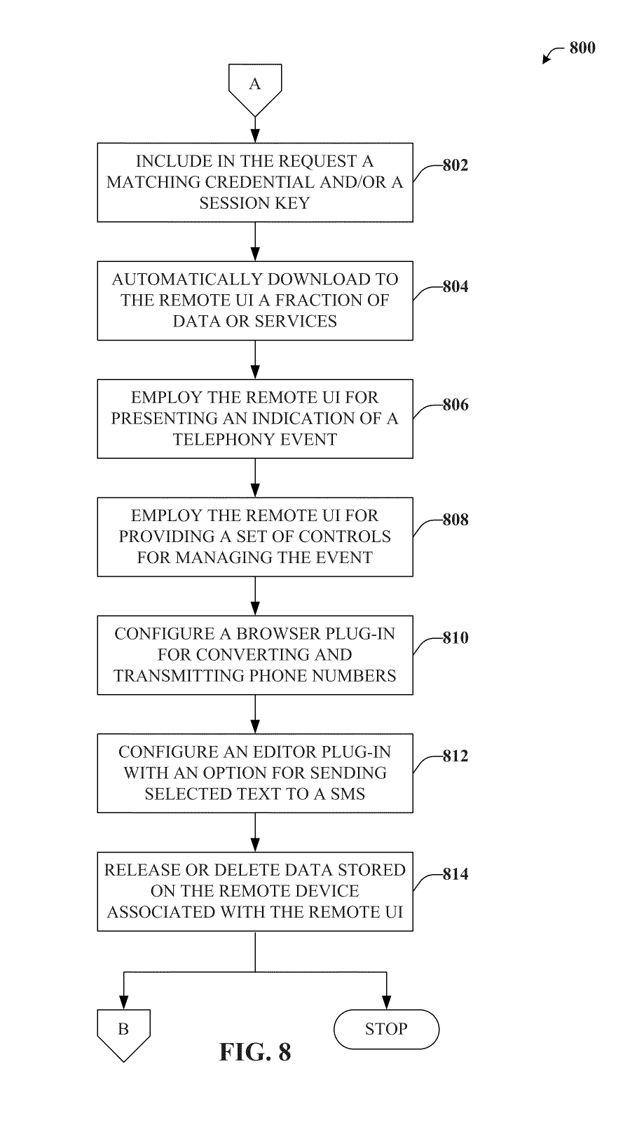

Turning now to FIG. 8, exemplary method 800 for providing additional features or aspects in connection with provision of a remote UI for a mobile device on a remote device is illustrated. For example, at reference numeral 802, at least one of a credential employed by the mobile for authenticating access to services or data, or a session key for encrypting data traversing the secure communication session can be included in the request transmitted in connection with reference numeral 702 of FIG. 7. In accordance therewith, and assuming the credential is determined by the mobile device to be valid, then the secure communication session can be established, with the session key employed for encrypting data traffic.

Furthermore, at reference numeral 804, a subset of data or services provided by the mobile device can be downloaded automatically to the remote UI. The particular subset selected can be based upon a usage context or based upon a data element priority. Accordingly, the remote UI constructed in connection with reference numeral 706 of FIG. 7 need not obtain all data and services provided by the mobile device in order to function. Rather, a streamlined subset of data and/or services can be delivered, with other data or services available upon request.

At reference numeral 806, the remote UI can be employed for presenting (either visually or audibly) an indication of at least one telephony event registering at the mobile device. In accordance therewith, at reference numeral 808, the remote UI can be employed for providing a set of controls for managing the at least one telephony event. Such controls can relate to, e.g., a control to utilize local resources to answer or initiate a call, a control to utilize native resources to answer or initiate the call, a control to ignore an incoming call, a control to send the incoming call to voicemail a control to forward the incoming call to another number, a control to present or mask contents of an incoming SMS, a control to initiate an outgoing SMS, a control to apply speech-to-text techniques and display contents of a voice message, a control to query or download additional data or services associated with the mobile device, and so forth.

In one or more aspect, at reference numeral 810, a browser plug-in, which can leverage browser applications extant on the remote device, can be configured for rendering detected phone numbers as clickable links that automatically transmit the detected phone number to the mobile device by way of the remote UI. Accordingly, the detected phone number can be stored as a contact by the mobile device and/or immediately dialed, either from the mobile device or the remote device.

Similarly, at reference numeral 812, an editor plug-in, which can leverage editor/word processing applications extant on the remote device, can be configured with an option for transmitting selected text to a native SMS of the mobile device by way of the remote UI. For example, an option can be integrated with context-sensitive menus accessed via right-click or the like. Moreover, in one or more aspect, at reference numeral 814, data stored on the remote device associated with the remote UI can be released or deleted upon detecting termination of the secure communication session.

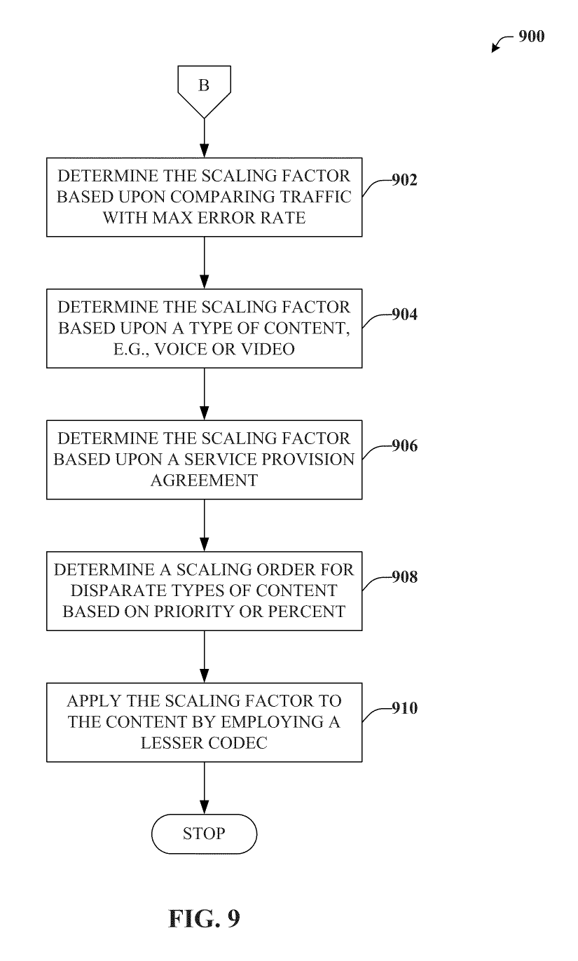

Now regarding FIG. 9, exemplary method 900 for providing additional features or aspects in connection with a mobile device coupled with a remote UI by way of a secure communication session is provided. At reference numeral 902, instructions or commands received from the remote UI can be executed on the mobile device in accordance with a native mobile OS. Moreover, at reference numeral 904, telephony events (e.g., incoming events) can be dynamically forwarded to the remote UI while the secure connection session is active. In addition, at reference numeral 906, telephony events forwarded to or commanded by the remote UI can be stored to a native mobile log of telephony events.

In one or more aspect, at reference numeral 908, the native mobile OS can be configured for supporting multiple contextual roles. Each, or at least one of the multiple contextual roles can employ unique sets of data, policies, services, or settings relative to other contextual roles, access to which can be based upon a selected contextual role. Last to be described, at reference numeral 910, the selected contextual role can be determined based upon input of one or more credential such as, e.g., the credential detailed in connection with reference numeral 802 of FIG. 8.

To provide further context for various aspects of the subject specification, FIG. 10 illustrates an example wireless communication environment 1000, with associated components that can enable operation of a femtocell enterprise network in accordance with aspects described herein. Wireless communication environment 1000 includes two wireless network platforms: (i) A macro network platform 1010 that serves, or facilitates communication) with user equipment 1075 via a macro radio access network (RAN) 1070. It should be appreciated that in cellular wireless technologies (e.g., 4G, 3GPP UMTS, HSPA, 3GPP LTE, 3GPP UMB), macro network platform 1010 is embodied in a Core Network. (ii) A femto network platform 1080, which can provide communication with UE 1075 through a femto RAN 1090, linked to the femto network platform 1080 through a routing platform 102 via backhaul pipe(s) 1085. It should be appreciated that femto network platform 1080 typically offloads UE 1075 from macro network, once UE 1075 attaches (e.g., through macro-to-femto handover, or via a scan of channel resources in idle mode) to femto RAN.

It is noted that RAN includes base station(s), or access point(s), and its associated electronic circuitry and deployment site(s), in addition to a wireless radio link operated in accordance with the base station(s). Accordingly, macro RAN 1070 can comprise various coverage cells like cell 1105, while femto RAN 1090 can comprise multiple femto access points. As mentioned above, it is to be appreciated that deployment density in femto RAN 1090 is substantially higher than in macro RAN 1070.

Generally, both macro and femto network platforms 1010 and 1080 include components, e.g., nodes, gateways, interfaces, servers, or platforms, that facilitate both packet-switched (PS) (e.g., internet protocol (IP), frame relay, asynchronous transfer mode (ATM)) and circuit-switched (CS) traffic (e.g., voice and data) and control generation for networked wireless communication. In an aspect of the subject innovation, macro network platform 1010 includes CS gateway node(s) 1012 which can interface CS traffic received from legacy networks like telephony network(s) 1040 (e.g., public switched telephone network (PSTN), or public land mobile network (PLMN)) or a SS7 network 1060. Circuit switched gateway 1012 can authorize and authenticate traffic (e.g., voice) arising from such networks. Additionally, CS gateway 1012 can access mobility, or roaming, data generated through SS7 network 1060; for instance, mobility data stored in a VLR, which can reside in memory 1030. Moreover, CS gateway node(s) 1012 interfaces CS-based traffic and signaling and gateway node(s) 1018. As an example, in a 3GPP UMTS network, gateway node(s) 1018 can be embodied in gateway GPRS support node(s) (GGSN).

In addition to receiving and processing CS-switched traffic and signaling, gateway node(s) 1018 can authorize and authenticate PS-based data sessions with served (e.g., through macro RAN) wireless devices. Data sessions can include traffic exchange with networks external to the macro network platform 1010, like wide area network(s) (WANs) 1050; it should be appreciated that local area network(s) (LANs) can also be interfaced with macro network platform 1010 through gateway node(s) 1018. Gateway node(s) 1018 generates packet data contexts when a data session is established. To that end, in an aspect, gateway node(s) 1018 can include a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can include multiple flows that can be generated through server(s) 1014. It is to be noted that in 3GPP UMTS network(s), gateway node(s) 1018 (e.g., GGSN) and tunnel interface (e.g., TTG) comprise a packet data gateway (PDG).

Macro network platform 1010 also includes serving node(s) 1016 that convey the various packetized flows of information or data streams, received through gateway node(s) 1018. As an example, in a 3GPP UMTS network, serving node(s) can be embodied in serving GPRS support node(s) (SGSN).

As indicated above, server(s) 1014 in macro network platform 1010 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can include add-on features to standard services provided by macro network platform 1010. Data streams can be conveyed to gateway node(s) 1018 for authorization/authentication and initiation of a data session, and to serving node(s) 1016 for communication thereafter. Server(s) 1014 can also effect security (e.g., implement one or more firewalls) of macro network platform 1010 to ensure network's operation and data integrity in addition to authorization and authentication procedures that CS gateway node(s) 1012 and gateway node(s) 1018 can enact. Moreover, server(s) 1014 can provision services from external network(s), e.g., WAN 1050, or Global Positioning System (GPS) network(s) (not shown). It is to be noted that server(s) 1014 can include one or more processor configured to confer at least in part the functionality of macro network platform 1010. To that end, the one or more processor can execute code instructions stored in memory 1030, for example.

In example wireless environment 1000, memory 1030 stores information related to operation of macro network platform 1010. Information can include business data associated with subscribers; market plans and strategies, e.g., promotional campaigns, business partnerships; operational data for mobile devices served through macro network platform; service and privacy policies; end-user service logs for law enforcement; and so forth. Memory 1030 can also store information from at least one of telephony network(s) 1040, WAN(s) 1050, or SS7 network 1060, enterprise NW(s) 1065, or service NW(s) 1067.

Femto gateway node(s) 1084 have substantially the same functionality as PS gateway node(s) 1018. Additionally, femto gateway node(s) 1084 can also include substantially all functionality of serving node(s) 1016. In an aspect, femto gateway node(s) 1084 facilitates handover resolution, e.g., assessment and execution. Further, control node(s) 1020 can receive handover requests and relay them to a handover component (not shown) via gateway node(s) 1084. According to an aspect, control node(s) 1020 can support RNC capabilities.

Server(s) 1082 have substantially the same functionality as described in connection with server(s) 1014. In an aspect, server(s) 1082 can execute multiple application(s) that provide service (e.g., voice and data) to wireless devices served through femto RAN 1090. Server(s) 1082 can also provide security features to femto network platform. In addition, server(s) 1082 can manage (e.g., schedule, queue, format . . . ) substantially all packetized flows (e.g., IP-based, frame relay-based, ATM-based) it generates in addition to data received from macro network platform 1010. It is to be noted that server(s) 1082 can include one or more processor configured to confer at least in part the functionality of macro network platform 1010. To that end, the one or more processor can execute code instructions stored in memory 1086, for example.

Memory 1086 can include information relevant to operation of the various components of femto network platform 1080. For example operational information that can be stored in memory 1086 can comprise, but is not limited to, subscriber information; contracted services; maintenance and service records; femto cell configuration (e.g., devices served through femto RAN 1090; access control lists, or white lists); service policies and specifications; privacy policies; add-on features; and so forth.

It is noted that femto network platform 1080 and macro network platform 1010 can be functionally connected through one or more reference link(s) or reference interface(s). In addition, femto network platform 1080 can be functionally coupled directly (not illustrated) to one or more of external network(s) 1040, 1050, 1060, 1065 or 1067. Reference link(s) or interface(s) can functionally link at least one of gateway node(s) 1084 or server(s) 1086 to the one or more external networks 1040, 1050, 1060, 1065 or 1067.

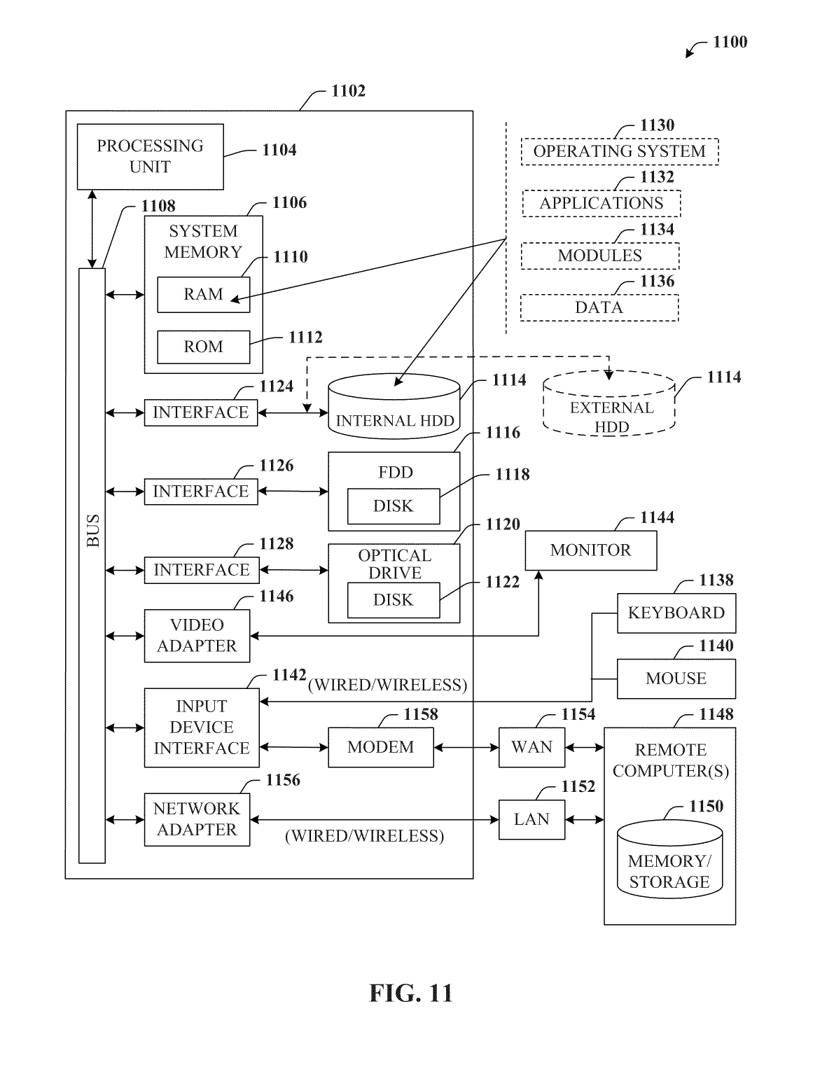

Referring now to FIG. 11, there is illustrated a block diagram of an exemplary computer system operable to execute one or more disclosed architecture. In order to provide additional context for various aspects of the disclosed subject matter, FIG. 11 and the following discussion are intended to provide a brief, general description of a suitable computing environment 1100 in which the various aspects of the disclosed subject matter can be implemented. Additionally, while the disclosed subject matter described above may be suitable for application in the general context of computer-executable instructions that may run on one or more computers, those skilled in the art will recognize that the disclosed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the disclosed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include either volatile or nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the disclosed subject matter includes a computer 1102, the computer 1102 including a processing unit 1104, a system memory 1106 and a system bus 1108. The system bus 1108 couples to system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE1394 interface technologies. Other external drive connection technologies are within contemplation of the subject matter disclosed herein.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the disclosed subject matter can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, a mobile device, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11(a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at 5.5-11 Mbps (802.11b) or 54 Mbps (802.11a) data rate, for example, or with products that contain both bands (dual band), so the networks can provide real-world performance similar to the basic “10BaseT” wired Ethernet networks used in many offices.

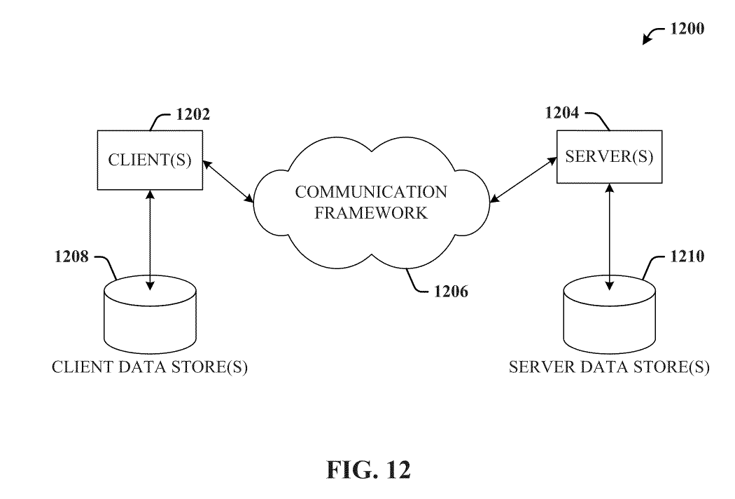

Referring now to FIG. 12, there is illustrated a schematic block diagram of an exemplary computer compilation system operable to execute the disclosed architecture. The system 1200 includes one or more client(s) 1202. The client(s) 1202 can be hardware and/or software (e.g., threads, processes, computing devices). The client(s) 1202 can house cookie(s) and/or associated contextual information by employing one or more embodiments described herein, for example.

The system 1200 also includes one or more server(s) 1204. The server(s) 1204 can also be hardware and/or software (e.g., threads, processes, computing devices). The servers 1204 can house threads to perform transformations by employing one or more embodiments, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

Various aspects or features described herein can be implemented as a method, apparatus, or article of manufacture using standard programming and/or engineering techniques. In addition, various aspects disclosed in the subject specification can also be implemented through program modules stored in a memory and executed by a processor, or other combination of hardware and software, or hardware and firmware. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disc (CD), digital versatile disc (DVD), blu-ray disc (BD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the internet or a local area network (LAN). Of course, those skilled in the art will recognize many modifications may be made to this configuration without departing from the scope or spirit of the disclosed subject matter.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that provides on a remote device a remote user interface (UI) associated with a mobile device, comprising:
a notification component configured to transmit a request to establish a secure connection session with a mobile device;
a communication component configured to utilize the secure connection session to access services associated with or data included in the mobile device; and
a UI component configured to utilize local computer-based resources to construct a remote UI adapted to operate the mobile device.

2. The system of claim 1, the request includes a credential that is identical to a native credential utilized by the mobile device to authenticate access to all or a portion of services or data.

3. The system of claim 1, the notification component transmits an initial request to a central server that operates a cloud service to support the remote UI, wherein the initial request includes a device ID associated with the mobile device.

4. The system of claim 3, wherein the device ID associated with the mobile device is at least one of a telephone number, an International Mobile Equipment Identity (IMEI), an International Mobile Subscriber Identity (IMSI), a Bluetooth-based Media Access Control (MAC) address, an ethernet MAC address, a wireless fidelity (WIFI) MAC address, a string identifier, a user name, a Uniform Resource Locator (URL), a Uniform Resource Identifier (URI), an email address, or a computed hash of one of or a combination of the above.

5. The system of claim 4, the notification component receives an initial response from the central server or the mobile device, wherein the initial response includes (1) a public key of a public/private key pair associated with the mobile device, and (2) a credential ID that defines a credential type required to authenticate access to the mobile device or a credential interface or application associated with the credential ID.

6. The system of claim 5, the UI component presents a credential interface based upon the credential type defined by the credential ID or based upon a default credential type; and the communication component employs the public key to encrypt a package included in the request, wherein the package includes (1) a credential that is input to the credential interface, and (2) a session key configured to encrypt communications propagated by way of the secure connection session.

7. The system of claim 1, the remote UI includes at least one of (1) a desktop UI that emulates all or a portion of at least one native display provided by an operating system of the remote device, (2) a short message service (SMS) UI that accesses a native SMS provided by the mobile device, (3) a phone UI that accesses a native phone service provided by the mobile device, or (4) a contacts UI that accesses a native contacts data store maintained by the mobile device.

8. The system of claim 7, the UI component automatically downloads a portion of data or services available from the mobile device based upon a context or a priority, and the UI component employs the portion of data or services to initially populate the remote UI.

9. The system of claim 1, the UI component presents an indication of one or more telephony events received by the mobile device based upon a type of telephony event, wherein the indication includes at least one of the type of telephony event, an identification of a sender of the one or more telephony event, an identification of a receiver of the one or more telephony event, or contents associated with the one or more telephony event.

10. The system of claim 9, the UI component provides a set of controls for managing the one or more telephony event based upon the type of telephony event, wherein the set of controls includes at least one of (1) a control to utilize local resources to answer or initiate a call, (2) a control to utilize native resources to answer or initiate the call, (3) a control to ignore an incoming call, (4) a control to send the incoming call to voicemail (5) a control to forward the incoming call to another number, (6) a control to present or mask contents of an incoming SMS, (7) a control to initiate an outgoing SMS, (8) a control to apply speech-to-text techniques and display contents of a voice message, or (9) a control to query or download additional data or services associated with the mobile device.

11. The system of claim 1, further comprising a browser plug-in configured to identify a phone number included in data to be rendered in a browser, and further configured to automatically convert an identified phone number to an interactive link displayed in the browser, wherein the interactive link facilitates transmission of the identified phone number to the mobile device by way of the remote UI.

12. The system of claim 1, further comprising a text editor plug-in configured to provide an option to automatically transmit highlighted text input to a text editor to a native SMS of the mobile device by way of the remote UI.

13. The system of claim 1, the UI component erases or releases data stored on local resources upon termination of the secure connection session.

14. A system that securely interfaces a mobile device to a disparate device that operates a remote user interface (UI), comprising:
a data store that stores a public key of a public/private key pair associated with a mobile device, and a device ID associated with the mobile device; and
a connection component configured to negotiate a secure connection session between the mobile device and a remote device configured to operate a remote UI for the mobile device.

15. The system of claim 14, further comprising a registration component configured to bind the public key to the device ID during a registration process that associates and stores the public key and device ID.

16. The system of claim 14, wherein the data store further stores a credential type registry that maintains a set of credential types and an associated set of credential type interfaces or applications.

17. The system of claim 16, wherein the connection component at least one of (1) negotiates the secure connection session based upon an initial request from the remote device, wherein the initial request includes the device ID; (2) polls the mobile device to determine a credential type; (3) retrieves an associated public key from the data store based upon the device ID, and a credential type interface or application based upon the credential type, (4) transmits the credential type interface or application and the public key to the remote device; (5) receives from the remote device a package encrypted with the public key that is decryptable by a private key maintained on the mobile device, wherein the package includes a credential derived from the credential type interface or application, and a session key configured to encrypt messages traversing the secure connection session; or (6) forwards the package to the mobile device as a request to establish the secure connection session.

18. A system that authenticates remote user interface (UI) access to a mobile device by way of a secure connection session, comprising:
an acquisition component configured to receive a request to establish a secure connection session with a remote device configured to operate a remote UI;
an authentication component configured to authenticate and establish the secure connection session based upon information included in the request; and
an interpretation component configured execute instructions received from the remote UI in accordance with a native mobile operating system (OS).

19. The system of claim 18, wherein the request includes a credential that is identical to a native credential utilized by the native mobile OS to authenticate at least one of a login, a release of a screen lock, or access to all or a portion of native data or services.

20. The system of claim 19, wherein the native mobile OS supports multiple native credentials, and wherein a particular native credential input defines an associated contextual role that utilizes unique data sets, policies, services, or settings that differ from other contextual roles associated with other of the multiple native credentials supported by the native mobile OS.

21. The system of claim 18, the interpretation component at least one of (1) forwards suitable telephony events to the remote UI while the secure connection session persists, or (2) logs telephony events according to protocol independently of whether or not telephony events are forwarded to or originate from the remote UI.

22. A method for providing a remote user interface (UI) for a mobile device on a remote device, comprising:
transmitting to a mobile device a request for a secure communication session between a remote device and the mobile device;
employing the remote device for accessing data included in or services associated with the mobile device by way of the secure communication session; and
employing computer-related resources included on the remote device for constructing a remote UI configured for operating the mobile device.

23. The method of claim 22, further comprising at least one of the following:
including in the request at least one of a credential that matches a native credential employed by the mobile device for authenticating access to services or data, or a session key for encrypting data traversing the secure communication session;
downloading automatically to the remote UI a subset of data or services provided by the mobile device based upon a context or a priority;
employing the remote UI for presenting an indication of at least one telephony event registering at the mobile device employing the remote UI for providing a set of controls for managing the at least one telephony event;
configuring a browser plug-in for rendering detected phone numbers as clickable links that automatically transmit the detected phone number to the mobile device by way of the remote UI;
configuring an editor plug-in with an option for transmitting selected text to a native short message service (SMS) of the mobile device by way of the remote UI; or
releasing or deleting data stored on the remote device associated with the remote UI upon detecting termination of the secure communication session.

24. The method of claim 22, further comprising at least one of the following:
executing commands, received from the remote UI, on the mobile device in accordance with a native mobile operating system (OS);
forwarding telephony events to the remote UI while the secure connection session is active;
storing telephony events forwarded to or commanded by the remote UI to a native mobile log of telephony events;
configuring the native mobile OS for supporting multiple contextual roles employing unique sets of data, policies, services or settings based upon a selected contextual role; or
determining the selected contextual role based upon input of one or more credential.

25. A system for providing on a remote device a remote user interface (UI) for a mobile device, comprising:
means for propagating to a mobile device a request for a secure connection session between the remote device and a mobile device;
means for utilizing the remote device for accessing data included in or services associated with the mobile device via the secure connection session; and
means for utilizing computer-based resources included on the remote device for constructing a remote UI configured for operating the mobile device.
